(19) United States
(12) Patent Application Publication
(10) Pub. No.: US 2006/0257720 A1
(43) Pub. Date: Nov. 16, 2006

(54) Conductive carbonaceous fiber woven cloth and solid polymer-type fuel cell

(75) Inventors: Satoshi Hirahara, Yokohama (JP); Mitsuo Suzuki, Yokohama (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: MITSUBISHI CHEMICAL CORPORATION, Tokyo (JP)

(21) Appl. No.: 11/488,721

(22) Filed: Jul. 19, 2006

Related U.S. Application Data
(63) Continuation of application No. 10/386,449, filed on Mar. 13, 2003, now abandoned.

(30) Foreign Application Priority Data
Mar. 13, 2002 (JP) 2002-068693

(51) Int. Cl. H01M 4/96; D03D 15/00; H01M 4/94; H01M 8/10; D01H 9/00

(52) U.S. Cl. 429/44; 442/21; 442/181; 429/30; 57/267

(57) ABSTRACT

The present invention provides a carbonaceous fiber woven fabric suitable for use as a gas diffusion layer material for solid polymer electrolyte fuel cells. Namely, the conductive carbonaceous fiber woven fabric of the present invention contains carbonaceous fiber yarns having a metric count of 16 to 120, a carbonaceous fiber content of at least 60% by weight, a weight per unit area of 50 to 150 g/m², a woven cloth thickness of 0.05 to 0.33 mm, and an in-plane volume resistivity of no more than 0.1 Ωcm.

### CROSS REFERENCE TO RELATED CASES

The present application claims priority to Japanese Patent Application No. JP 2002-068693, filed on Mar. 13, 2002, which is hereby incorporated by reference in its entirety.

### BACKGROUND OF THE INVENTION

1. Field of the Invention

The present invention relates to a conductive carbonaceous fiber woven fabric comprising carbonaceous fibers. The carbonaceous fiber woven fabric of the present invention has an excellent electrical conductivity, gas permeability, water-holding property and water-releasing property. Accordingly, the conductive carbonaceous fiber woven fabric of the present invention is suitable for use as a gas diffusion layer material for solid polymer electrolyte fuel cells. Based on the high output densities afforded by the solid polymer electrolyte fuel cells employing the carbonaceous fiber woven fabric of the present invention as a gas diffusion layer material, these fuel cells may be used as power sources for motor vehicles and power sources for cogeneration power systems.

2. Discussion of the Background

Recently, considerable research efforts have been focused on developing fuel cells. The fuel cells that are being developed due to these efforts are classified into groups based on the electrolyte utilized. Examples of some of these groups include: alkaline fuel cells, phosphoric acid fuel cells, molten carbonate fuel cells, solid electrolyte fuel cells, and solid polymer electrolyte fuel cells. Of these groups, solid polymer electrolyte fuel cells are attracting attention as power sources for electric cars and domestic power sources since these fuel cells can be operated at low temperatures, are easy to handle, and can attain a high output density. Investigations are also underway with respect to the application of such fuel cells to a cogeneration system in which the heat evolved during electrical power generation is utilized for heating, hot-water supply, etc., thereby the overall heat efficiency is improved.

The main components of each single cell in a solid polymer electrolyte fuel cell include: a membrane electrode and ribbed separators. The membrane electrode is basically composed of a solid polymer electrolyte membrane (ion-exchange membrane) and, in order, a catalyst layer, gas diffusion layer, and a current collector bonded to each side of the electrolyte membrane. The catalyst layer primarily consists of a mixture of a catalyst and carbon black. Under certain circumstances the gas diffusion layers may also function as current collectors. Sandwiching this membrane electrode between ribbed separators give a single cell of a solid polymer electrolyte fuel cell.

A solid polymer electrolyte fuel cell, as described above, works by the following mechanism. A fuel (hydrogen gas) and an oxidizing agent (oxygen-containing gas) are fed into the anode-side catalyst layer and the cathode-side catalyst layer, respectively, through the grooves of the ribbed separators to cause cell reactions. The resultant flow of electrons generated through the membrane electrode is removed as electrical energy. In order for the fuel cell to work efficiently by this mechanism, it is necessary to smoothly and evenly feed the fuel and the oxidizing agent to the membrane electrode. It is also important that the solid electrolyte membrane located at the center of the membrane electrode retain a moderate amount of water so as to have proton conductivity (water-holding property). The water that forms as a result of the cell reactions should be smoothly discharged therefrom (water-releasing property). However, the water-holding property and the water-releasing property are antithetical to each other and, therefore, it is generally difficult to simultaneously satisfy both of these properties.

Mainly used for producing a membrane electrode are: a method comprising bonding catalyst layers to a solid electrolyte membrane to form a multilayer structure and then bonding gas-diffusing current collectors to that structure; and a method comprising bonding gas-diffusing current collectors respectively to catalyst layers to form multilayer structures and then bonding these structures to a solid electrolyte membrane.

Carbon papers are mainly used as a material of the gas diffusion layers (sometimes functioning also as current collectors). Although many processes for carbon paper production are known (see, JP-A-50-25808, JP-A-61-236664, JP-A-61-236665, and JP-A-1-27969), all the carbon papers produced by the known processes are composed of a carbonaceous material, e.g., short carbon fibers, bonded with a binder. In carbon papers having this composition, the thickness-direction electrical conductivity thereof is lower than the in-plane electrical conductivity thereof, although the in-plane conductivity is satisfactory. With respect to mechanical properties, these carbon papers have a high stiffness but are relatively brittle and poorly elastic. As a result, when such a carbon paper is used in fabricating a solid polymer electrolyte fuel cell and a pressure is applied thereto, so as to reduce electrical resistance at contact points, the carbon paper is apt to break. Thereby, a reduction, rather than an increase, in electrical conductivity occurs. Moreover, these carbon papers have insufficient gas permeability in in-plane directions, although satisfactory in thickness-direction gas permeability. Due to these properties, use of these carbon papers as gas diffusion layers have a disadvantage in that the gas which is being fed through the grooves of a ribbed separator is inhibited from diffusing in transverse directions, leading to a decrease in cell performance.

Research is also focused on using a carbonaceous fiber woven fabric made by weaving carbonaceous fibers as a substitute for the carbon papers. Carbonaceous fiber woven fabrics have many advantages over the carbon papers, e.g., freedom from mechanical brittleness, high gas permeability, and the ability to have elasticity also in the thickness direction according to the constitution of carbonaceous fibers or weave construction.

Since carbonaceous fiber woven fabrics generally possess a high gas diffusivity and permeability compared to carbon papers and the like, the woven fabrics have advantages as a gas diffusion layer material, such as a smooth supply of fuel gas and excellent releasing properties of generated water. However, in spite of the very good water-releasing properties, there arises a problem of inferior cell performance owing to a poor water-holding property. Furthermore, since the contact points between fibers are not fixed in the carbonaceous fiber woven fabrics, electrical resistance in these points is unstable and this tends to result in unstable electrical resistance of the woven fabric as a whole.

Many proposals have been made on techniques for eliminating the problems of carbonaceous fiber woven fabrics. For example, JP-A-58-165254 discloses a technique in which pores of a carbonaceous fiber woven fabric are filled with a mixture of a fluororesin and carbon black. JP-A-10-261421 discloses a technique in which a layer comprising a fluororesin and carbon black is formed on a surface of a carbonaceous fiber woven fabric.

However, these techniques have drawbacks in that they deteriorate cell properties owing to an increased electrical resistance. In addition, these techniques reduce gas diffisivity, which are an advantage of carbonaceous fiber woven fabrics, because they control water-holding property, water-releasing property, gas permeability, and the like of the gas diffusion layer by filling the carbonaceous fiber woven fabrics with a fluororesin, carbon black, etc.

Accordingly, an object of the present invention is to provide an excellent conductive carbonaceous fiber woven fabric, which is suitable for use as a gas diffusion layer material for solid polymer fuel cells and that provide a well-balanced water-holding property, gas diffusivity and water-releasing property, as well as an improved working stability.

### SUMMARY OF THE INVENTION

As a result of the extensive studies, the present inventors have found that the above object can be achieved by constituting a woven fabric by relatively fine yarns of carbon fibers and controlling a weight per unit area (Metsuke amount), a thickness of the woven fabric, and a volume resistivity. Namely, the conductive carbonaceous fiber woven fabric of the present invention is mainly constituted by carbonaceous fiber yarns having a metric count of 16 to 120, a carbonaceous fiber content of at least 60% by weight, a weight per unit area of 50 to 150 g/m², a woven cloth thickness of 0.05 to 0.33 mm, and an in-plane volume resistivity of not more than 0.1 Ωcm.

The above objects highlight certain aspects of the present invention. Additional objects, aspects and embodiments of the present invention are found in the following detailed description of the present invention.

### DETAILED DESCRIPTION OF THE INVENTION

Unless specifically defined, all technical and scientific terms used herein have the same meaning as commonly understood by a skilled artisan.

All methods and materials similar or equivalent to those described herein can be used in the practice or testing of the present invention, with suitable methods and materials being described herein. All publications, patent applications, patents, and other references mentioned herein are incorporated by reference in their entirety. In case of conflict, the present specification, including definitions, will control. Further, the materials, methods, and examples are illustrative only and are not intended to be limiting, unless otherwise specified.

The present invention is based in part on the Inventor's surprising discovery that the object of the present invention can be achieved by constituting a woven fabric by relatively fine yarns of carbon fibers and controlling a weight per unit area (Metsuke amount), a thickness of the woven fabric, and a volume resistivity. Namely, the conductive carbonaceous fiber woven fabric of the present invention is mainly constituted by carbonaceous fiber yarns having a metric count of 16 to 120, a carbonaceous fiber content of at least 60% by weight, a weight per unit area of 50 to 150 g/m², a woven cloth thickness of 0.05 to 0.33 mm, and an in-plane volume resistivity of not more than 0.1 Ωcm.

The conductive carbonaceous fiber woven fabric of the present invention is a thin woven fabric into which relatively fine yarns are woven so as to result in narrow spaces between the yarns. The woven fabric of the present invention provide a high level and well-balanced properties such as gas permeability, water-releasing property, water-holding property and electrical conductivity, which are required of the gas diffusion, layer for fuel cells.

The yarns constituting the woven fabric of the present invention may be any of single yarns, two-folded yarns, three-folded yarns, filament yarns, and also composite yarns composed of carbonaceous fibers of different raw threads. The fineness of yarn (metric count) is from 16 to 120 in terms of metric count. The yarns having a metric count of 16 to 120 is preferably selected from the group consisting of two-folded yarns of 2/32 to 2/120 Nm and single yarns having a metric count of 1/16 to 1/60 Nm. It is technically difficult to produce yarns having a fine metric count and, therefore, only carbonaceous fiber woven fabrics using yarns having a thick size of metric count is known. However, it is inevitable to make a texture coarse for producing a thin woven fabric having good gas permeability and water-releasing property with yarns having a thick size of metric count. Moreover, it is difficult for such a woven fabric that to maintain water-holding property and also to keep in-plane electrical conductivity at a constant value because the woven points tend to move.

As used herein, when reference is made to the fineness of yarns as a fraction, the numerator in the fraction refers to the classification as “two-folded” or “single.” For example, in the preceding paragraph reference is made to two-folded yarns (2/x, where x=metric count) having a metric count of 2/32 to 2/120 Nm and single yarns (1/x, where x=metric count) having a metric count of 1/16 to 1/60 Nm. Further, as used herein the unit “Nm” is as commonly accepted by the skilled artisan.

The present inventors have found that industrial production of yarns having a fine metric count of 16 or higher is possible, even in carbonaceous fibers. In addition, the present inventors have succeeded in satisfying various properties required of the gas diffusion layer for fuel cells by constituting a woven fabric by yarns of a fine metric count of 16 or higher. The yarns of carbonaceous fibers constituting the woven fabric are preferably those of 18 metric count or higher, especially 20 metric count or higher. However, the finer metric count of yarn, the more difficult and expensive the production is and the weaker the strength of the yarn is.

Also, it becomes difficult to produce an even woven fabric with yarns thinner than those having 120 metric count.

Therefore, as the yarns constituting the woven fabric, those having 120 metric count or lower are used. Particularly, it is preferable to use the yarns having 60 metric count or lower. In this connection, the production of carbonaceous fibers includes steps of spinning, oxidization, carbonation, and (graphitization), the fineness of yarn decreases about 10% during the steps of carbonization and further graphitization of oxidized fibers. In the present invention, the size of the yarns constituting the woven fabric means that of the yarns of finally obtained woven fabric and the size can be measured by analyzing a yarn taken out of the woven fabric.

The conductive carbonaceous fiber woven fabric is mainly composed of yarns of carbonaceous fibers having a metric count of 16 to 120. Herein, the term “mainly” means that at least 60% by weight of yarns constituting the woven fabric are yarns of carbonaceous fibers having a metric count of 16 to 120. In this connection, yarns of carbonaceous fibers having a metric count other than 16 to 120 may be used as constituent components within the range in which the properties are not impaired.

The twist number of yarns is measured in accordance with JIS L 1095 (General spun yarn test method). In the case of single yarns, the number is preferably from 300 to 800, especially from 500 to 700, per meter of the yarn length. In the case of two-folded yarns, the number of final twists and the number of primary twists are preferably from 300 to 800 and from 500 to 900, respectively, per meter of the yarn length, and are especially from 400 to 750 and from 600 to 850, respectively, per meter. In both cases of single yarns and two-folded yarns, if the twist number becomes too large the likelihood of breakage of fibers and unevenness of yarn thickness increases. As a result, the woven fabric formed also tends to have an uneven thickness, which may result in impaired water-holding and water-releasing properties, as well as a tendency of reduced electrical conductivity. On the other hand, if the twist number is too small, uneven thickness also tends to result.

The yarns to be used for producing the woven fabric may be either filament yarns or spun yarns as mentioned above. However, spun yarns are suitable because a dense and even woven fabric structure is obtained therefrom and yarn productivity is high.

For obtaining spun yarns, any known spinning technique may be used. Examples thereof include spinning methods such as cotton spinning, 2-inch spinning, tow spinning, worsted spinning, woolen spinning, and direct spinning.

The spun yarns may be two-folded yarns or single yarns, but two-folded yarns are preferable because a woven fabric having an even thickness can be generally produced owing to the larger tensile strength than that of single yarns.

The following will show one example of spinning into yarns of carbon fibers having a fine size of metric count.

As mentioned below, a variety of precursors of carbonaceous fibers can be used as the raw materials. However, spun yarns are obtained by using polyacrylonitrile-based fiber tow subjected to an oxidizing treatment, obtaining slivers by stretch-breaking it in one stage, and then spinning them. The term “one stage” as used herein means between the rollers in the first stage of a stretch-breaking machine (i.e., between the first pair of rollers an the second pair of rollers). The following will explain the process in more detail.

[Polyacrylonitrile-Based Fiber Tow Subjected to Oxidizing Treatment]

Raw materials for polyacrylonitrile-based fibers include a variety of materials defined by the content of acrylonitrile units as mentioned below. However, fibers starting with any material can be used. Polyacrylonitrile-based fiber tow can be obtained by spinning these materials in a usual manner.

The above polyacrylonitrile-based fiber tow is subjected to an oxidizing treatment as mentioned below.

The flame-resistance of the above polyacrylonitrile-based fiber tow subjected to an oxidizing treatment is evaluated by the limiting oxygen index (LOI value). The LOI value of the above fiber tow is generally at least 20, preferably at least 35.

In the case that the LOI value is lower than 35, there is an advantage that it is easy to obtain oxidized spun yarns having a relatively fine size of metric count because fibers are apt to be crimped and have a high strength. However, when a woven fabric obtained by weaving yarns derived from fiber tow having such a low LOI value is carbonized and graphitized, monofilaments after carbonization/graphitization have an extremely lowered strength and were embrittled, and as a result, the strength of the resulting woven fabric tends to decrease.

On the other hand, when a woven fabric obtained by weaving yarns derived from fiber tow having a high LOI value is carbonized and graphitized. Monofilaments after carbonization/graphitization have an increased strength, so that the value is preferably as high as possible. However, when the LOI value is too high, it becomes difficult to crimp fibers and hence spinning properties decreases, so it becomes difficult to obtain spun yarns of oxidized fibers. Therefore, the value is controlled to generally no more than 65, preferably no more than 55.

Accordingly, the flame-resistance of polyacrylonitrile-based fiber tow is preferably as mentioned below.

The LOI value (limiting oxygen index) is a measure of combustibility of fibers, woven fabric and the like and obtained by measuring according to a method in accordance with JIS K 7201.

[Spinning Method of Oxidized Fibers]

Oxidized spun yarns are produced by subjecting oxidized continuous filament tow of polyacrylonitrile-based fiber tow to individual production steps (1) stretch-breaking (stretch-cutting), (2) drawing (gill), (3) roving (bobbiner), (4) fine spinning, and (5), in the case of two-folded yarns, yarn doubling/twisting, successively.

It is particularly important to stretch-break (stretch-cut) a continuous filament tow of oxidized fibers in one stage. Furthermore, in the drawing step, needle action such as gill should be from zero to two times and it is important to reduce considerably the repeating times at each step as compared with the case of spinning common fibers such as acrylic fibers.

(Stretch-Breaking Step)

A stretch-breaking machine of a continuous filament tow to be used in the stretch-breaking (stretch-cutting) step has a plurality of rollers capable of controlling their intervals in the stretch-breaking region of the stretch-breaking machine. Accordingly, the machine permits multistage continuous stretch-breakage of the filament tow and stretch-breaks the filament tow with holding the tow by individual rollers. By stretch-breaking the tow substantially in one stage, it is possible to obtain yarns of a fine size of metric count. Specifically, the interval of rollers in the first stage in the stretch-breaking region is, for example, adjusted to 100 to 150 mm and the interval of rollers in the second stage is adjusted to at lest 10 mm or more larger than the interval of the first stage rollers, so that stretch-breakage substantially in only one stage is achieved. It is preferable to control feeding speed and tension of the filament tow for the purpose of preventing occurrence of partial breakage without draft. Further, it is preferable to adhere an appropriate oily agent homogeneously to the filament tow and slivers before or after stretch-breakage for the purpose of suppressing occurrence of static electricity and enhancing converging property of the tow.

Moreover, in order to enhance the spinning property in the next step, it is preferred to crimp slivers at a crimper portion before or after stretch-breakage. In particular, after continuous filament tow whose electrical resistance is adjusted to 5 to 9 GΩ by adhering an oily agent to enhance antistaticity before stretch-breakage is stretch-broken in one stage. It is preferred to adhere an additional oily agent having an action to enhance converging property to the crimper portion following the stretch-breaking region for the purpose of crimping the resulting slivers and enhancing converging property at the same time.

(Drawing Step)

In the drawing (gill draft) step as a next step of the stretch-breaking step, gill is not used (gill zero time) or is repeated at most two times in order to reduce amount of short fibers generated by monofilaments breakage by needle action of gill faller (a needle-implanted bar which applies carding action onto fibers through its movement) and leave crimp of slivers for keeping converging property of the slivers as far as possible. In further consideration of productivity, one time is substantially preferable.

(Roving Step)

In the roving step following the drawing step, bobbiner is repeated from one to three times, preferably two times in order to reduce occurrence of yarn breakage and winding to rolls and machine of the roving step. Moreover, it is preferable that doubling is zero or two per one bobbiner and the draft ratio is 3-fold per one bobbiner.

(Fine Spinning Step)

Draft ratio at fine-spinning of raw yarns after the final bobbiner step is 5-fold to 20-fold, preferably 12-fold to 18-fold in view of a little occurrence of yarn breakage or winding and a stable production of spun yarns.

In this connection, since draft ratio in each step varies depending on the filament number of the continuous filament tow to be used, the ratio is not limited to the above as far as spun yarns having a desired size of metric count.

The woven fabric may be a plain weave, a twill weave, a sateen weave, or any other weave construction but a plain weave is preferable because volume resistivity of the woven fabric becomes small owing to the largest number of crossing of warps and wefts per unit area.

In the case where the yarns are subjected to plain weaving, the yarn input (number of warps and number of wefts per unit length) is generally from 30 to 70 yarns per inch but specifically it is optionally selected depending on kinds of yarns (single yarns or two-folded yarns) and yarn diameter. For example, when two-folded spun yarns of 2/40 Nm are used as warps and wefts, the yarn input for each of the warps and the wefts is generally from 100 to 300 yarns, preferably from 180 to 250 yarns, per 10 cm of the woven fabric. The spaces between warps and wefts preferably have a size of from 10 to 150 μm in terms of the diameter of corresponding pores as measured with a scanning electron microscope, from the standpoint of securing water-holding/water-releasing properties during use as a gas diffusion material in fuel cells.

A preferred example of the woven fabric is one obtained by weaving two-folded yarns having a metric count of 40 to 60 composed of monofilaments having a diameter of 7 to 10 μm by plain weaving at a warp density and a weft density of 30 to 70 yarns per inch each.

The thickness of the conductive carbonaceous fiber woven fabric is at least 0.05 mm. When the thickness of the woven fabric is less than 0.05 mm, the woven fabric has too low a tensile strength. The thickness of the woven fabric is preferably at least 0.10 mm, especially at least 0.20 mm. Conversely, when the thickness of the woven fabric exceeds 0.33 mm, the woven fabric has reduced gas diffusivity. Moreover, a membrane electrode produced using the woven fabric is too bulky and, hence, the resulting fuel cell has a reduced output per unit volume. Furthermore, the use of such a membrane electrode may cause deteriorated cell properties because even constriction is difficult at its stacking and, hence, properties such as electrical resistance and gas permeability of each cell tend to be uneven. The thickness of the woven fabric is preferably not more than 0.30 mm, especially not more than 0.28 mm.

The weight per unit area of the woven fabric is generally at least 50 g/m². When the weight per unit area of the woven fabric is less than 50 g/m², the stiffness and tensile strength of the woven fabric are too small. The weight per unit area is preferably at least 60 g/m², especially at least 80 g/m. The upper limit of the weight per unit area is not more than 150 g/m, preferably not more than 120 g/m². When the weight per unit area exceeds 150 g/m², the woven fabric is too dense and has reduced gas diffusivity.

Lower in-plane volume resistivity is preferred for the woven fabric. However, the woven fabric having the resistivity of not more than 0.1 Ωcm is sufficient for practical use as the gas diffusion layer for solid polymer fuel cells. The volume resistivity thereof is preferably not more than 0.09 Ωcm. The value is more preferably not more than 0.07 Ωcm, especially not more than 0.06 Ωcm. Lower limit of in-plane volume resistivity is generally 0.02 Ωcm for the ranges of the fineness of yarn, thickness, and weight per unit area of the woven fabric of the present invention.

The conductive carbonaceous fiber woven fabric of the present invention is excellent in gas diffusivity. Lower limit of the gas diffusivity thereof is generally 50 cm³/cm².sec, preferably 60 cm³/cm².sec, in terms of air permeability as measured in accordance with JIS L 1096, air permeability test (method A). Moreover, upper limit thereof is generally 130 cm³/cm².sec, preferably 120 cm³/cm².sec.

When the air permeability thereof exceeds 130 cm³/cm².sec, the woven fabric tends to have reduced water-holding property although it has sufficient gas permeability. On the other hand, when the air permeability is less than 50 cm³/cm².sec, the woven fabric, when used in high-output applications where a high current should be produced in a moment, such as polymer electrolyte membrane fuel cells for motor vehicles, has insufficient gas permeation and tends to result in reduced cell performance. Of course, the woven fabric having an air permeation of less than 50 cm³/cm².sec can be adequately used for low-output applications such as domestic fuel cells.

Although the monofilaments of the carbonaceous fibers having a diameter of about 3 μm are known, the monofilaments constituting the woven fabric of the present invention preferably have a diameter of at least 6 μm, especially at least 7 μm. Although carbonaceous fibers composed of monofilaments having a smaller diameter generally have high strength but are expensive, there is no need of using such expensive carbonaceous fibers because the carbonaceous fibers to be used in the present invention are not required to have especially high strength. Use of carbonaceous fibers composed of monofilaments having a large diameter is disadvantageous in that they tend to give woven fabrics having a higher degree of unevenness of thickness. Therefore, the filaments having a diameter of not more than 70 μm are usually used. Preferably, those having a diameter of not more than 50 μm, especially not more than 30 μm are used.

Metallic impurities present in the woven fabric are preferably diminished to the lowest possible level because the impurities can be a factor that, during fuel cell operation, accelerates hydrolysis of the water being generated and thereby reduces cell properties. For example, the contents of iron, nickel, and sodium are preferably not more than 50 μg/g, not more than 50 μg/g, and not more than 100 μg/g, respectively. The contents of metallic impurities can be reduced by washing a woven fabric, carbonaceous fibers to be used as a material for the fabric, raw fibers for the carbonaceous fibers, or the like with an acid such as hydrochloric acid or acetic acid.

As the carbonaceous fibers constituting the conductive carbonaceous fiber woven fabric of the present invention can be used any known carbonaceous fibers such as polyacrylonitrile-based, pitch-based, cellulose-based, polynosic-based, phenol resin-based and a mixture thereof. Usually, pitch-based or polyacrylonitrile-based carbonaceous fibers are used. Preferred of these are polyacrylonitrile-based carbonaceous fibers. The polyacrylonitrile-based carbonaceous fibers are available in various grades according to the proportion of acrylonitrile units in the raw material. Examples of the fibers include those formed from polyacrylonitrile having almost 100% acrylonitrile unit content, those formed from acrylonitrile-based polymers having an acrylonitrile unit content of at least 50%, and those formed from acrylonitrile polymers having an acrylonitrile unit content of from 20 to 50%. Carbonaceous fibers obtained from any of these raw materials can be used.

Carbonizing the above precursors for the carbonaceous fibers, i.e., polyacrylonitrile-based, pitch-based, cellulose-based, polynosic-based, phenol resin-based or a mixture thereof, or other known any fibers produces the carbonaceous fibers.

The conductive carbonaceous fiber woven fabric of the present invention can be produced by a variety of methods. One method thereof comprises weaving the aforementioned carbonaceous fibers into a woven fabric. In addition to the method of weaving carbonaceous fibers, weaving precursor fibers for carbonaceous fibers and then carbonizing and optionally further graphitizing the woven fabric obtained can also produce the conductive carbonaceous fiber woven fabric.

A preferred process for this production is as follows: Polyacrylonitrile-based fibers, which are a direct precursor for polyacrylonitrile-based carbonaceous fibers, are subjected to an oxidizing treatment at 200 to 300° C. in air to obtain oxidized fibers. The oxidized fibers are woven to obtain an oxidized woven fabric. This fabric is heated in an inert gas atmosphere such as nitrogen or argon to carbonize the fibers. The resulting fabric may be further heated to a high temperature, if desired, to graphitize the fibers. Thus, a conductive carbonaceous fiber woven fabric according to the present invention can be obtained. The polyacrylonitrile-based fibers to be subjected to the oxidizing treatment may be either long fibers or spun fibers of short fibers, and may be either single yarns or two-folded yarns. During the oxidizing treatment, the fibers may be stretched to thereby improve toughness of the fibers.

The carbonization of the oxidized fiber woven fabric may be conducted in an inert gas by heating at a temperature of 400 to 1,400° C., preferably from 600 to 1,300° C. From the standpoint of the electrical conductivity of the woven fabric, it is preferred to heat the fabric to at least 700° C., especially at least 800° C., more preferably at least 900° C. When graphitization is desired, this may be accomplished by further heating the woven fabric to 1,400 to 3,000° C., preferably 1,500 to 2,500° C. In this connection, it is preferable to press the woven fabric before carbonization and graphitization in order to make the thickness of the woven fabric even.

The oxidizing treatment (treatment for imparting non-melting property) is a chemical reaction by which oxygen is introduced into the molecular structure of the pitch or polyacrylonitrile. This treatment is accomplished by keeping a precursor of carbonaceous fibers in contact with oxygen for several tens of minutes at a temperature that is generally from 200 to 300° C. and is less than 400° C. at the highest. In general, the larger the amount of oxygen incorporated into the molecular structure, the higher the effect of preventing fusion bonding during successive carbonization. The amount of oxygen necessary for fiber burning which is generally called an LOI value is generally used as a measure of the effect. It is said that the oxidizing treatment should be carried out so as to obtain oxidized fibers having an LOI value of 35 to 40 in order to avoid fusion bonding as in the case of producing common carbonaceous fibers. However, in the production of the carbonaceous fiber woven fabric of the present invention, it is preferred to carry out an oxidizing treatment so as to obtain oxidized fibers having an LOI value of 20 to 55.

That is, in the case where carbonaceous fibers constituting the woven fabric are purposely not fused, it is preferred to carry out an oxidizing treatment so as to obtain oxidized fibers having an LOI value of 35 to 55. In contrast, in the case where improvement of fuel cell properties is intended by fusion bonding fibers to form a woven fabric having stiffness, it is preferred to perform the oxidizing treatment so as to obtain oxidized fibers having an LOI value of not more than 35, especially not more than 33. However, since fibers having too small a value of LOI undergo excess fusion at successive carbonization to give a brittle carbonaceous fiber woven fabric, it is preferred to carry out an oxidizing treatment so as to result in an LOI value of at least 20, especially at least 25. Changing the contact temperature and contact time with oxygen at the oxidizing treatment can control the LOI value.

In addition to being obtained by weaving oxidized fibers, the conductive carbonaceous fiber woven fabric of the present invention can be produced by weaving polyacrylonitrile-based fibers themselves, which are a precursor for the oxidized fibers, to obtain a woven fabric and subjecting this woven fabric to an oxidizing treatment and carbonization and optionally to graphitization. In this case, an oxidized woven fabric having an LOI value within the aforementioned range may be obtained by bringing the woven fabric into contact with an oxidizing gas such as air, ozone, or nitrogen oxide or with sulfuric acid, nitric acid, or the like.

The conductive carbonaceous fiber woven fabric obtained by any of the methods described above can be used, without any treatment, as a gas diffusion layer material in fuel cells. However, this woven fabric may be further processed before being used as a gas diffusion layer material. For example, the conductive carbonaceous fiber woven fabric obtained above can be modified so as to have the functions of enabling the membrane electrode to retain a moderate amount of water, adsorptively removing impurities contained in the fuel or oxidizing agent fed to the cell, and thereby preventing deterioration of the cell properties. This can be achieved by bringing the conductive carbonaceous fiber woven fabric into contact with water vapor or carbon dioxide having a temperature of about 800 to 1,200° C. or with air having a temperature of about 300 to 500° C. to gasify part of the carbonaceous material, whereby micropores were formed in the carbonaceous fibers to obtain a woven fabric composed of porous carbonaceous fibers. It is preferred that not only the conductive carbonaceous fiber woven fabric obtained through this treatment for imparting porosity but also the conductive carbonaceous fiber woven fabrics obtained by the various methods described above is finished by pressing so as to have an even and given thickness. Pressing can easily regulate the thickness of the woven fabric.

Moreover, 100% by weight of the conductive carbonaceous fiber woven fabric obtained above is composed of carbonaceous fibers, but conductive substances such as powdery activated carbon, conductive carbon black, carbonized products of various pitches may be additionally incorporated thereto. For example, there may be mentioned those obtained by dissolving pitch in an organic solvent to form a pitch solution, applying a suspension of powdery activated carbon or conductive carbon black suspended therein onto the woven fabric obtained above and then heating the coated fabric in an inert gas to carbonize the pitch. Also, in that case, the content of the carbonaceous fibers in the woven fabric is at least 60% by weight, preferably at least 80% by weight.

The conductive carbonaceous fiber woven fabric of the present invention can be advantageously used as the gas diffusion layers of fuel cells. For example, pastes each obtained by mixing a dispersion of polytetrafluoroethylene with a catalyst and carbon black are applied respectively on a solid polymer electrolyte membrane to obtain a bonded structure composed of a solid polymer electrolyte membrane and catalyst layers. The conductive carbonaceous fiber woven fabric according to the present invention is bonded as a gas diffusion layer to the boded structure, whereby a membrane electrode can be formed. The bonded structure comprising a solid polymer electrolyte membrane and catalyst layers may be formed also by a method comprising applying pastes of a polytetrafluoroethylene dispersion, a catalyst, and carbon black onto a release sheet to form catalyst layers and then bonding the catalyst layers to a solid polymer electrolyte membrane by hot pressing. Alternatively, use may be made of a method comprising applying the catalyst pastes respectively to conductive carbonaceous fiber woven fabrics according to the present invention to form structures each composed of a gas diffusion layer and a catalyst layer and then bonding these structures to a solid polymer electrolyte membrane by hot pressing, whereby a membrane electrode can be formed. In any of these methods, the conductive carbonaceous fiber woven fabric according to the present invention can be easily handled because it has moderate stiffness.

The solid polymer electrolyte fuel cells using the carbonaceous fiber woven fabric according to the present invention are suitably used as power sources for motor vehicles and power sources for cogeneration power systems.

In a specific embodiment of the present invention is a conductive carbonaceous fiber woven fabric consisting essentially of the carbonaceous fiber yarns of the present invention.

To obtain a further understanding of the terms “mounted” and “installed,” the artisan is referred to Leaversuch (2001) Fuel Cells; Jolt Plastics Innovation. Plastics Technology. 47(11): 48-53, which is incorporated herein by referencein its entirety.

Having generally described this invention, a further understanding can be obtained by reference to certain specific examples, which are provided herein for purposes of illustration only, and are not intended to be limiting unless otherwise specified.

### EXAMPLES

### Example 1

Oxidized polyacrylonitrile fibers having an LOI value of 50 obtained by subjecting polyacrylonitrile fibers to an oxidizing treatment with air were spun to produce slivers. These slivers were then subjected to fine spinning to produce two-folded yarns having a metric count of 26 (2/51 Nm).

(Raw Materials of Fibers)

An oily agent having antistatic activity was adhered to a polyacrylonitrile-based continuous filament tow substantially uncrimped and oxidized to yield an LOI value of 50 (Number of filaments: 6000, Elemental composition: carbon 61%, hydrogen 3%, nitrogen 21%, oxygen 15%). Thereby the electrical resistance of the filaments was regulated to 6 GΩ.

(Stretch-Breaking Step)

A one-stage stretch-breakage process was employed to produce slivers. In this process, slivers were hung to produce a shape of a swirl after passing through the crimper portion, subsequent to stretch-breakage with addition of an oily agent having a convergence activity to the crimper portion.

(Drawing Step)

One portion (no doubling) of the slivers obtained by the stretch-breakage process was subjected to a single drafting step at a draft ratio of 10-fold. Draft spots and sliver breakage did not occurred after the drafting step.

(Roving and Fine Spinning Step)

One portion (no doubling) of the slivers taken after the drawing step was roved to obtain raw yarns. The raw yarns were subjected to fine spinning to attain 2/51 Nm on a fine spinning machine, and thereby obtain two-folded yarns having a metric count of 51 (2/51 Nm). The number of final twists and the number of primary twists of the resulting spun yarns were 450/m and 730/m, respectively. The number of fluffs present on the yarns was counted with a commercial optical fluff counter (SHIKIBO F-INDEX TESTER). As a result, the number of fluffs of 3 mm or longer was found to be 300 per 10 m of the yarns.

The two-folded yarns were used as warps and wefts to conduct plain weaving at a warp density of 51 yarns per inch and a weft density of 45 yarns per inch to obtain an oxidized woven fabric. This oxidized woven fabric was then carbonized at 950° C. in a nitrogen atmosphere and further graphitized at 2,300° C. under a vacuum to obtain a conductive carbonaceous fiber woven fabric in accordance with the present invention. The resulting conductive carbonaceous fiber woven fabric had a warp density of 60 yarns per inch (corresponding to 236 yarns per 10 cm) and a weft density of 54 yarns per inch (corresponding to 213 yarns per 10 cm). Physical properties of the conductive carbonaceous fiber woven fabric of this Example are shown in Table 1.

### Example 2

A conductive carbonaceous fiber woven fabric having a warp density of 46 yarns per inch and a weft density of 45 yarns per inch was obtained in the same manner as described in Example 1 with the following exception. In this Example, an oxidized woven fabric was produced by using two-folded yarns having a metric number of 20 (2/40 Nm), obtained by spinning oxidized fibers of polyacrylonitrile in the same manner as in Example 1, as warps and wefts to conduct plain weaving at a warp density and a weft density of 40 yarns per inch and 38 yarns per inch, respectively. Physical properties of the conductive carbonaceous fiber woven fabric of this Example are shown in Table 1.

### Example 3

A conductive carbonaceous fiber woven fabric having a warp density of 45 yarns per inch and a weft density of 43 yarns per inch was obtained in the same manner as described in Example 1 with the following exception. In this Example, an oxidized woven fabric was produced by using two-folded yarns having a metric count of 17 (2/34 Nm), obtained by spinning oxidized fibers of polyacrylonitrile in the same manner as in Example 1, as warps and single yarns having a metric number of 17 (1/17 Nm) as wefts to conduct plain weaving at a warp density and a weft density of 38 yarns per inch and 37 yarns per inch, respectively. Physical properties of the conductive carbonaceous fiber woven fabric of this Example are shown in Table 1.

### Comparative Example 1

Physical properties of a commercially available carbonaceous fiber woven fabric (i.e., a carbonaceous fiber woven fabric manufactured by Textron) are shown in Table 1. A carbonaceous fiber woven fabric having a warp density of 45 yarns per inch and a weft density of 40 yarns per inch was obtained by carbonizing an oxidized fiber fabric. In turn the oxidized fiber fabric was obtained by weaving two-folded yarns having a metric count of 15 (2/30 Nm) as warps at a warp density of 35 yarns per inch and two-folded yarns having a metric count of 14 (2/28 Nm) as wefts at a weft density of 35 yarns per inch. Both of the yarns used for warps and wefts were spun yarns of oxidized fibers of polyacrylonitrile.

TABLE 1

| | | | Volume | |
|---|---|---|---|---|
| | Thickness¹ | Weight² | resistivity³ | Gas diffusivity⁴ |
| | (mm) | (g/m²) | (Ωcm) | (cm³/cm² · sec) |
| Example 1 | 0.24 | 90 | 0.02 | 98 |
| Example 2 | 0.27 | 105 | 0.02 | 100 |
| Example 3 | 0.28 | 102 | 0.02 | 118 |
| Comparative | 0.39 | 120 | 0.02 | 135 |
| Example 1 | | | | |

¹Measured under a load of 8 g/cm².
²Calculated from the weight of a cut sample of 40 cm square.
³Measured with a constant-current electric resistance meter (LORESTA AP, DIAINSTRUMENTS INC.)
⁴Measured in accordance with JIS L 1096, Air Permeability Test (frazil method).

When the diffusivity is 50 cm³/cm²·sec or higher, it is possible to use the conductive carbonaceous fiber woven fabric as a gas diffusion layer for solid polymer fuel cells.

The woven fabric of Comparative Example 1 has very good gas diffusivity. However, this woven fabric has inferior water-holding properties, as well as an uneven thickness owing to the large thickness. Therefore, the woven fabric of Comparative Example 1 possesses inferior overall cell properties.

In contrast, the woven fabric of Examples 1 to 3, which are in accordance with the present invention, have good gas diffusivity, good water-holding properties, and little unevenness in the thickness owing to the small thickness. Therefore, the woven fabrics in accordance with the present invention provide a good cell performance.

Accordingly, the carbonaceous fiber woven fabric according to the present invention has excellent electrical conductivity, gas permeability, water-holding property, and water-releasing property and is, therefore, suitable for use as a gas diffusion layer material for solid polymer electrolyte fuel cells. The solid polymer electrolyte fuel cells using the carbonaceous fiber woven fabric of the present invention can be suitably used as power sources for motor vehicles and power sources for cogeneration power systems.

Numerous modifications and variations on the present invention are possible in light of the above teachings. It is, therefore, to be understood that within the scope of the accompanying claims, the present invention may be practiced otherwise than as specifically described herein.

What we claim is:

1. A conductive carbonaceous fiber woven fabric comprising carbonaceous fiber yarns having a metric count of 16 to 120, a carbonaceous fiber content of at least 60% by weight, a weight per unit area of 50 to 150 g/m², a woven cloth thickness of 0.05 to 0.33 mm, and an in-plane volume resistivity of no more than 0.1 Ωcm.

2. The conductive carbonaceous fiber woven fabric according to claim 1, wherein the metric count is 16 to 60.

3. The conductive carbonaceous fiber woven fabric according to claim 1, wherein the weight per unit area is 60 to 150 g/m².

4. The conductive carbonaceous fiber woven fabric according to claim 1, wherein said conductive carbonaceous fiber woven fabric has a gas diffusivity of 50 to 130 cm³/cm²·sec as an air permeability determined in accordance with JIS-L-1096, method A.

5. The conductive carbonaceous fiber woven fabric according to claim 1, wherein said conductive carbonaceous fiber woven fabric has a weave construction that is a plain weave and has a yarn input for each of warps and wefts which is 30 to 70 per inch.

6. The conductive carbonaceous fiber woven fabric according to claim 1, wherein the carbonaceous fibers are monofilaments having a diameter of 6 to 50 μm.

7. The conductive carbonaceous fiber woven fabric according to claim 1, wherein said yarn is a spun yarn.

8. The conductive carbonaceous fiber woven fabric according to claim 7, wherein said conductive carbonaceous fiber woven fabric comprises warps and wefts, wherein the warps, the wefts, or the warps and the wefts are two-folded yarns.

9. The conductive carbonaceous fiber woven fabric according to claim 7, wherein said yarn are selected from the group consisting of two-folded yarns having a metric count of 2/32 to 2/120 Nm and single yarns having a metric count of 1/16 to 1/60 Nm.

10. The conductive carbonaceous fiber woven fabric according to claim 1, wherein the carbonaceous fiber yarns are carbonized products of acrylic fibers obtained by spinning a polymer containing monomer units derived from acrylonitrile.

11. A solid polymer electrolyte fuel cell comprising a conductive carbonaceous fiber woven fabric according to claim 1 as a gas diffusion layer material.

12. The solid polymer electrolyte fuel cell according to claim 11, further comprising a solid polymer electrolyte membrane, a catalyst layer, and a current collector.

13. A motor vehicle comprising the solid polymer electrolyte fuel cell according to claim 11 mounted therein.

14. A cogeneration power system comprising the solid polymer electrolyte fuel cell according to claim 11 installed therein.

15. The conductive carbonaceous fiber woven fabric according to claim 1, obtained by a process comprising: (a) weaving a precursor of carbonaceous fibers and (b) carbonizing the woven material.

16. A solid polymer electrolyte fuel cell comprising a conductive carbonaceous fiber woven fabric according to claim 15 as a gas diffusion layer material.

17. The solid polymer electrolyte fuel cell according to claim 16, further comprising a solid polymer electrolyte membrane, a catalyst layer, and a current collector.

18. A motor vehicle comprising the solid polymer electrolyte fuel cell according to claim 16 mounted therein.

19. A cogeneration power system comprising the solid polymer electrolyte fuel cell according to claim 16 installed therein.

20. A method of producing a conductive carbonaceous fiber woven fabric according to claim 1, comprising:
(a) producing oxidized spun yarns by:
(i) producing slivers by stretch-breaking a continuous filament tow;
(ii) drawing said slivers;
(iii) roving said slivers; and
(iv) fine spinning the slivers obtained after roving to obtain raw yarns wherein said raw yarns are selected from the group consisting of two-folded yarns having a metric count of 2/32 to 2/120 Nm and single yarns having a metric count of 1/16 to 1/60 Nm; and
(b) weaving a conductive carbonaceous fiber woven fabric from said oxidized spun yarns.

21. A conductive carbonaceous fiber woven fabric consisting essentially of carbonaceous fiber yarns having a metric count of 16 to 120, a carbonaceous fiber content of at least 60% by weight, a weight per unit area of 50 to 150 g/m², a woven cloth thickness of 0.05 to 0.33 mm, and an in-plane volume resistivity of no more than 0.1 Ωcm.
